(19) United States
(12) Patent Application Publication
(10) Pub. No.: US 2007/0058088 A1
(43) Pub. Date: Mar. 15, 2007

(54) Image-projection system with imager provided with a color wheel having a plurality of sub- sets of colored segments, and corresponding projection appliance

(75) Inventors: Arno Schubert, Chevaigne (FR); Thierry Borel, Noyal Sur Vilaine (FR); Khaled Sarayeddine, Nouvoitou (FR); Julien Thollot, Treves (FR)

Correspondence Address: THOMSON LICENSING INC., PATENT OPERATIONS, PO BOX 5312, PRINCETON, NJ, 08543-5312, US

(73) Assignee: THOMSON LICENSING, F-92100 BOULOGNE-BILLANCOURT (FR)

(21) Appl. No.: 10/555,928

(22) PCT Filed: May 7, 2004
(86) PCT No.: PCT/FR04/50185

§ 371 Date: Nov. 8, 2005

(30) Foreign Application Priority Data
May 9, 2003 (FR) 03/05652

(51) Int. Cl. G03B 21/00; H04N 9/12; G02B 7/00

(52) U.S. Cl. 348/743; 359/892; 353/31

(57) ABSTRACT

System for the sequential illumination of an imager comprising a color wheel comprising at least two coplanar subsets of three colored segments The color wheel comprises at least one subset of segments of primary colors 61R, 61G and 61B, and one subset of segments of composite colors. The subset of segments of composite colors comprises a segment transmitting in the ranges of wavelengths corresponding to red and to green, a segment transmitting in the ranges of wavelengths corresponding to green and to blue, and a segment transmitting in the ranges of wavelengths corresponding to red and to blue. Thus, the luminosity of image display systems is improved, and the phenomenon of “color break-up” is appreciably reduced. Corresponding projection appliance.

The invention relates to systems for the sequential illumination of an imager or spatial light modulator (SLM) used in certain image projection and/or viewing systems.

The systems for projecting and/or viewing images commonly known as projectors or backprojectors depending on whether the projection is from in front of the screen in the case of projectors, or behind in the case of backprojectors, all work on the same principle. An illumination system uniformly illuminates one or several images comprising an array of pixels, for example of the liquid-crystal on silicon (LCOS) or digital micro-mirror device/display (DMD) or transmissive high temperature polysilicon (HTPS) type, arranged for example in rows and columns on a substrate forming an active matrix, particularly made of silicon. The light from the illumination system is modulated having passed through the imager or imagers, in the case of transmissive imagers, or having reflected off the imager or imagers in the case of reflective imagers, for example of the LCOS or DMD type. The light thus modulated is then projected onto a screen through a projection lens. In order to generate color images, the imager or imagers are illuminated with one or more beams of colored light, generally red, green and blue light (RGB).

Some image projection and/or viewing systems comprise three imagers, each of the imagers being illuminated by a beam of colored light corresponding to one of the three primary colors, RGB. These three-imager image-viewing systems are complicated since the three beams of colored light which have passed through or been reflected off the imagers have to be combined to form only a single beam of modulated light ready to be projected onto a screen. Aside from the number of imagers used, these image viewing systems require the use of bulky and expensive optical elements. There are image projection and/or viewing systems comprising two imagers in existence, such as, for example, the image projection system described in IBM's U.S. Pat. No. 5,863,125. In that document, each imager is alternately illuminated with a beam of colored light so that the electronic addressing of the data for the writing of the pixels of a frame and the stabilization of said pixels associated with the response times of the liquid crystals can take place on the imager which is not being illuminated. This period, of the order of a few milliseconds, during which an imager cannot be illuminated is termed the “dead time”. The image projection system described in IBM's document has the advantage of managing this dead time, although it remains complex and expensive because of the presence of the two imagers. In addition, imagers of the liquid crystal on silicon (LCOS) or digital micro-mirror device/display (DMD) type for example are exhibiting dead times which are not as long as they were before, and imagers of the DMD type can actually operate at high frequencies in excess of 400 Hz for example.

Thus, for some years now, the trend has been toward image projection systems involving just one imager, known as mono-valve systems, of the transmissive or reflective type, which are less bulky and less expensive than the image projection systems involving several imagers.

In order to generate color images, the projection systems of this type sequentially display images of different colors in the screen, generally the three primary colors of red, green and blue, RGB. These image projection systems generally comprise illumination devices for illuminating the sole imager with a light that alternates between red, green and blue through the use of color wheels for example. These color wheels generally comprise a red segment, a green segment and a blue segment, RGB, which are transmissive, through the use of color filters, for example, or reflective. The video data commanding the writing of the pixels of the imager are synchronized with the color of illumination of the imager so as to form an image that presents the viewer with the fewest possible number of defects. However, the image projection and/or viewing systems that use a single imager of this type do have certain disadvantages by comparison with multi-imager systems. For example, the imager needs to operate at high frequencies, generally three times the image frequency in the case of a color wheel having three segments of primary colors namely at least 150 to 180 Hz, and more generally n times the frequency of the images when using a color wheel having n segments of primary colors. In addition, given that just one color is displayed at a time, a significant proportion of the luminous flux from the light source is lost. Thus, in order to improve the luminosity of the projected images, some color wheels comprise a white segment, such as, for example, the device described by Texas Instruments in U.S. Pat. No. 5,233,385. This device allows brighter images to be displayed, at the expense of the color quality as the colors become desaturated (less bright) because of the presence of polychromatic light of white appearance. Another disadvantage associated with the sequential display of images of different colors on a screen is the perception by the viewer of the decomposition or split of the primary colors RGB when, for example, certain objects in the image are moving quickly or when there is a sudden movement of the eyes, a blinking, visual judder or any other sharp variation in the viewing conditions. This color break-up phenomenon also manifests itself in stationary images, for example when the viewer's eyes scan the screen rapidly or in the case of pictures that are moving rapidly with respect to a stationary viewer. One of the ways to reduce this color break-up phenomenon is to increase the display and/or sequential illumination frequency of the imager. Some color wheels comprise six color segments, for example in the form of two coplanar subsets of three segments colored RGB as described in Texas Instrument's American U.S. Pat. No. 5,448,314. The frequency of display and/or of sequential illumination of the imager is thus doubled, although transitions from red illumination to green followed by blue illumination remain sudden, and the color break-up phenomenon is lessened but still remains clearly visible to certain viewers who are more sensitive than others to this kind of phenomenon.

One object of the invention is to avoid these disadvantages.

To this end, the invention relates to a system for the sequential illumination of an imager comprising a source emitting, toward the imager, a beam of polychromatic light in the range of wavelengths containing at least red, green and blue, optical means for uniformly distributing the light from the source over the working area of the imager, a color wheel comprising at least two coplanar subsets of transmissive segments, and positioned in such a way that at least one of these segments intersects said beam, mounted on rotation means in such a way as to cause said segments to file in sequence past said beam intersection region, each subset of segments comprising three segments of different colors, the tint, saturation, transmissivity and size of which are tailored to make up a reference white when they file in sequence past said intersection region, the color wheel comprising at least one subset of primary colors comprising a segment transmitting in the range of wavelengths corresponding to red, a segment transmitting in the range of wavelengths corresponding to green, and a segment transmitting in the range of wavelengths corresponding to blue, characterized in that said color wheel comprises at least one subset of coplanar segments of composite colors comprising a segment transmitting at least in part both in the ranges of wavelengths corresponding to red and to green, a segment transmitting at least in part both in the ranges of wavelengths corresponding to green and to blue, and a segment transmitting at least in part both in the ranges of wavelengths corresponding to red and to blue, none of said composite colors of said segments taken separately generating a white tint. One advantage of the presence of the subset of segments of composite colors is that each segment of composite colors is equivalent to two segments of primary colors of the same size. Thus, a color wheel comprising, for example, a subset of three segments of primary colors and a subset of three segments of composite colors, all the segments being the same size, is equivalent to a wheel comprising virtually nine segments of primary colors of the same size. This results in a gain in luminosity of the order of 50%. In addition, the color wheel of the illumination device comprises, for example, six colored segments of different colors which, when the wheel is rotated, insect the beam of polychromatic light emitted by the light source in sequence in such a way that the imager is illuminated sequentially with a frequency which is twice the frequency of illumination of a device comprising a color wheel having three color segments. The increase in the illumination frequency in the imager contributes to advantageously reducing the color break-up phenomenon.

IBM's U.S. Pat. No. 5,863,125 describes a color wheel comprising two subsets of colored segments. However, unlike our invention, this is an illumination system with spatio-chromatic splitting to illuminate two imagers, and the segments on the color wheel are not coplanar (FIG. 4).

According to various embodiments, said range of wavelengths of the beam of polychromatic light emitted by the source also comprises yellow and/or cyan. This involves using light sources that are commonplace in the field of image projectors (video), the costs of which are tending to drop and the life of which is tending to increase, without being restricted to a specific type of source.

According to another feature of the invention, in the at least one coplanar subset of segments of composite colors, said segment transmitting at least in part both in the ranges of wavelengths corresponding to red and to green also transmits at least in part in the range of wavelengths corresponding to yellow, and/or said segment transmitting at least in part both in the ranges of wavelengths corresponding to green and to blue also transmits at least in part in the range of wavelengths corresponding to cyan, and/or said segment transmitting at least in part both in the ranges of wavelengths corresponding to red and to blue also transmits at least in part in the ranges of wavelengths corresponding to magenta. The use of color filters also transmitting in the ranges of the wavelengths corresponding to cyan and/or to yellow and/or to magenta as far as the composite color segments are concerned allows transmission of said ranges of wavelengths when these are emitted by the light source. Thus, the color wheel according to the invention, comprising a subset of segments in composite colors in addition to the subset of primary colors, transmits a flux of photons which, when averaged over one revolution of the wheel, is greater than the flux of photons transmitted by a color wheel comprising two conventional subsets of primary colors as described in the aforementioned prior art. This then advantageously contributes to increasing the luminous flux of the image, in other words the luminosity. According to another feature of the invention, the segments of each coplanar subset are positioned in such a way that each segment of composite color is positioned between the two segments of primary color that this composite color segment transmits. This specific position of the segments of composite colors with respect to the segments of primary colors makes it possible to reduce the color break-up significantly. Specifically, the sudden switch from a segment with the primary color red, for example, to a segment with the primary color green, as described in the aforementioned prior art, is advantageously softened by the presence, between these two segments of primary colors, of the segment of composite colors transmitting at least partially both in the ranges of the wavelengths corresponding to red and to green and/or to yellow.

According to one embodiment of the invention, said color wheel comprises at least one coplanar subset of segments of desaturated colors comprising a segment transmitting in the range of wavelengths corresponding to red desaturated with respect to the red of the coplanar subset of segments of primary colors, a segment transmitting in the range of wavelengths corresponding to green, desaturated with respect to the green of the coplanar subset of segments of primary colors, and a segment transmitting in the range of wavelengths corresponding to blue, desaturated with respect to the blue of the coplanar subset of segments of primary colors. Thus, given that the segments of desaturated colors allow through a greater photon flux from the light source than do the segments of non-destaturated primary colors, the luminosity of the image, averaged over one revolution of the wheel, is improved. In addition, in the embodiment whereby each segment of desaturated color is adjacent to the segment of primary color of the equivalent tint, in the direction of rotation of the color wheel, the switches between two segments of primary colors are made less abrupt through the intermediate presence of said segment of desaturated color, the color break-up phenomenon is also reduced.

According to another feature, said color wheel has no black segment. Liquid crystal imagers, for example LCOS imagers, have a dead time period of the order of a few milliseconds while the data for writing the pixels of a frame is being electronically addressed and while said pixels are being stabilized because of the response time of the liquid crystals. This is why, since the imager cannot be illuminated during this period, some color wheels also comprise black segments in order to block out the light beam. Since the overall luminosity of the system is reduced by doing this, it is preferable to use a wheel without a black segment. This is now possible with the use of imagers of the DMD type which have practically no dead time period and also with the use of the new generation LCOS imagers which have memories or transistors at each pixel or group of pixels and also now have practically no dead time period. The reduction or complete elimination of the time for which black or very dark elements appear on the screen, as a result of the black segments on the color wheel, makes it possible to lessen the perceived phenomenon of color break-up between each chromatic image displayed by the sequential illumination system.

This in particular presents the advantage of increasing the luminous flux of the image viewing system according to the ratio of the time for which black segments are present to the time of the frame.

Thus, the luminosity of the images composed using a color wheel containing no black segment(s) is better, and the color break-up is less noticeable.

According to one-feature of the invention, said illumination device is contained within an image projection and/or viewing system itself further comprising:
an imager itself comprising an array of pixels arranged in rows and columns,
a projection lens designed to project the image from said imager onto a projection screen.
   The image viewing and/or projection system thus obtained has, in particular, a high level of luminosity and a color break-up phenomenon that is practically unnoticeable to the viewer.

According to another feature of the invention, said system for viewing and/or projecting images comprising the illumination device according to the invention, comprises video data management means for managing the video data of said images so as to command writing of the pixels of the imager, synchronizing means for synchronizing the video output data according to the color of illumination on the imager, said video data management means comprising a video input interface for receiving the video input data regarding primary colors, a video output interface for sending the video output data for writing to the imager, and a memory. The video data management means comprise, in memory, at least one table of coefficients and/or values for converting the video input data regarding primary colors into video output data regarding primary colors, composite colors and, as appropriate, desaturated colors.

The video data management means thus convert the video data from the three, R, G and B, parallel buses into a single bus delivering, in series, the data corresponding to the various segments of the color wheel.

According to one feature of the invention, said video output data regarding primary colors and/or composite colors and/or desaturated colors from the video data management means are synchronized with the color of illumination on the imager. Thus, the viewer sees a better quality color image, without color mixing effects.

The invention also relates to a system for the sequential illumination of an imager comprising:
a source emitting, toward the imager, a beam of polychromatic light in the range of wavelengths containing at least red, green and blue,
optical means for uniformly distributing the light from the source over the working area of the imager, and
a color wheel comprising at least two coplanar subsets of reflective segments, and positioned in such a way that at least one of these segments intersects the beam, mounted on rotation means in such a way as to cause the segments to file in sequence past the beam intersection region, each coplanar subset of segments comprising three coplanar segments of different colors, the tint, saturation, reflectivity and size of which are tailored to make up a reference white when they file in sequence past said intersection region, the color wheel comprising at least one subset of segments of primary colors comprising a segment reflecting in the range of wavelengths corresponding to red, a segment reflecting in the range of wavelengths corresponding to green, and a segment reflecting in the range of wavelengths corresponding to blue.

The color wheel is notable in that it comprises at least one subset of coplanar segments of composite colors comprising a segment reflecting at least in part both in the ranges of wavelengths corresponding to red and to green, a segment reflecting at least in part both in the ranges of wavelengths corresponding to green and to blue, and a segment reflecting at least in part both in the ranges of wavelengths corresponding to red and to blue, none of the composite colors of one and the same segment generating a white tint.

Furthermore, the invention relates to a projection appliance comprising at least one imager, a system for the sequential illumination of each of the imagers, as defined hereinabove according to the invention, and means for projecting an image created by said imager or imagers.

The invention will be better understood from reading the description which will follow, given by way of nonlimiting example and with reference to the attached figures in which:

FIG. 1 schematically depicts the main elements of an image projection system with a single imager or single valve system;

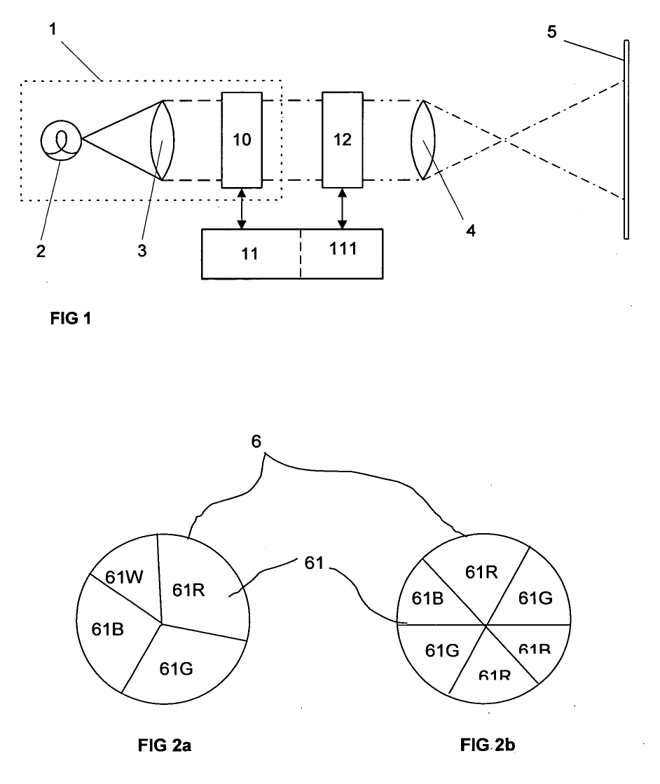

FIG. 2a shows a color wheel comprising three color segments and a segment of white tint, and FIG. 2b shows a color wheel comprising six colored segments RGB as described in the prior art;

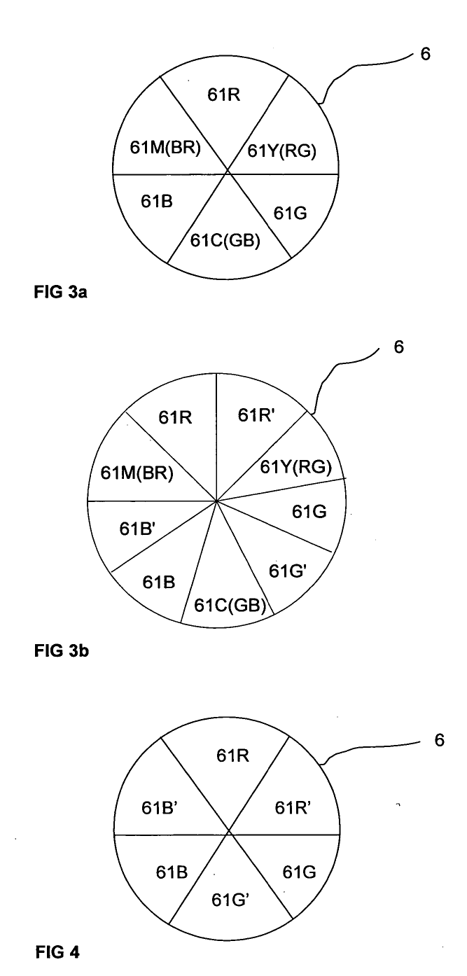

FIG. 3a shows a color wheel which comprises, according to a preferred embodiment of the invention, two coplanar subsets of three segments of different colors, one subset of primary colors and one subset of composite colors;

FIG. 3b comprises, according to another embodiment of the invention, a subset of three segments of desaturated primary colors in addition to the two subsets of the color wheel depicted in FIG. 3a;

FIG. 4 shows a color wheel comprising, in particular, a subset of segments of primary colors and a subset of desaturated primary colors;

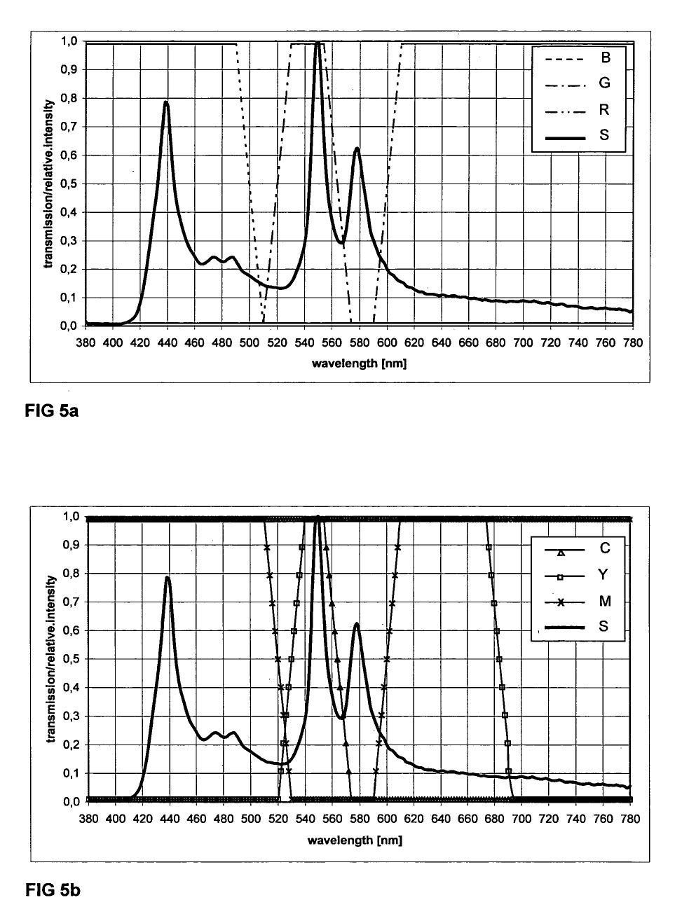

FIGS. 5a and 5b each depict a graph showing, respectively:
in the case of FIG. 5a, the emission spectrum of a common light source and the ranges of the wavelengths that the primary color RGB filters transmit;
in the case of FIG. 5b, the emission spectrum for the same common light source and the ranges of wavelengths transmitted by the composite color yellow (R+G), magenta (B+R) and cyan (G+B) filters;

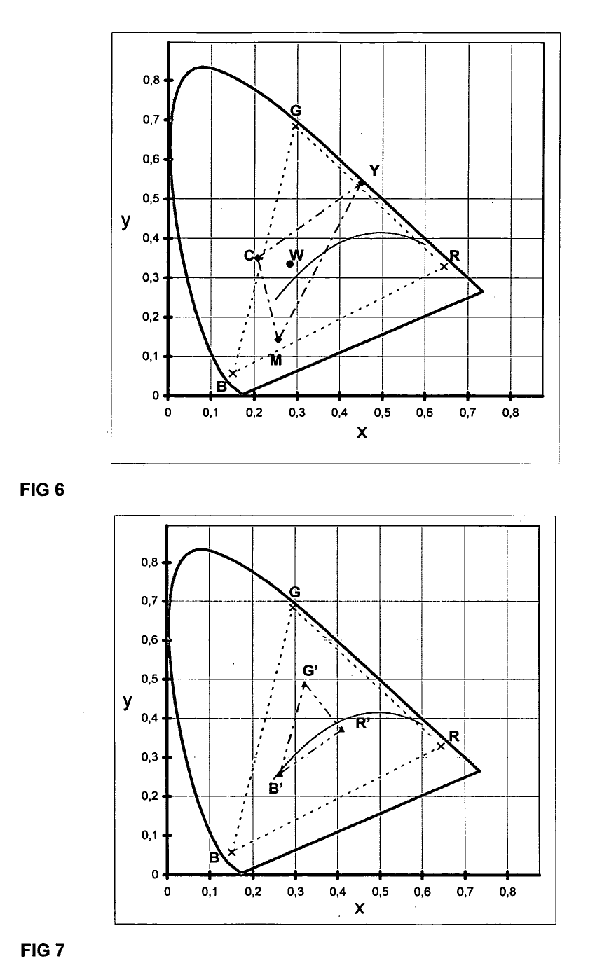

FIG. 6 shows the CIE 1931 (International Commission on Illumination) chromaticity diagram for the colors transmitted through a color wheel comprising a subset of segments of composite colors according to a preferred embodiment of the invention;

FIG. 7 shows the CIE 1931 (International Commission on Illumination) chromaticity diagram for the colors transmitted through a color wheel comprising a subset of segments of desaturated primary colors according to another embodiment of the invention;

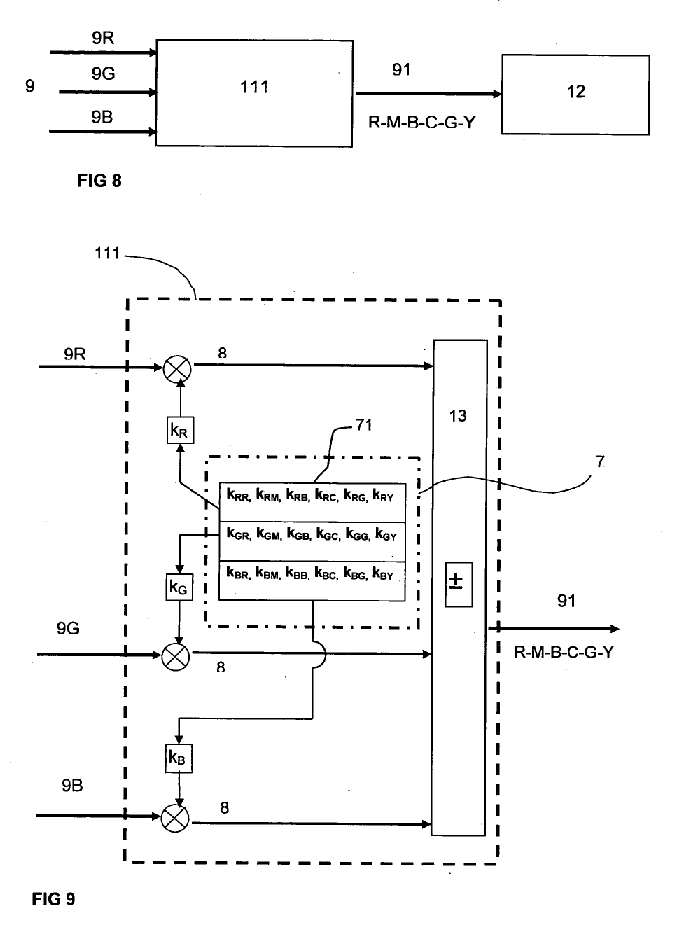

FIGS. 8 and 9 show the video data management means according to a preferred embodiment of the invention.

In order to simplify the description and reveal the differences and advantages that the invention has to offer over the prior art, identical references are used for elements that fulfill the same functions.

The general principle of operation of a system for viewing and/or projecting images of the type comprising one imager is described with reference to FIG. 1.

A projection system comprising a single imager or single valve system is depicted schematically in FIG. 1. The system comprises an illumination system 1 comprising in particular a light source 2 which sends light onto a chromatic splitter 10, for example tasked with sequentially illuminating the single imager 12 with a beam of light colored alternately red, green and blue (RGB) or alternatively with splitting the light from the source 2 into bands of light of different colors (a process known as color scrolling) through an intermediate optical device 3, generally a collimating device. Color scrolling illumination systems will not be described in greater detail hereinafter.

The light from the illumination system 1 illuminates a transmissive or reflective imager 12 comprising an array of pixels the writing of which is managed by video data management means 111 associated in particular with synchronizing means 11 to synchronize the light from the illumination system 1 with the video data originating from said video data management means or, conversely, to synchronize the video data commanding the writing of the pixels of the imager 12 so as to modulate the incident light, according to the illumination color received. After transmission, or reflection, at the imager 12, light thus modulated is projected onto a screen 5 via a projection lens 4 The devices 3 and 4, together with the light source 2, are known per se and will not be described further hereinafter.

The sequential chromatic splitter 10 according to the invention comprises a color wheel 6. A color wheel is to be understood as meaning a disk mounted at its axis on rotation means, comprising transmissive colored segments or sectors 61, generally red 61R, green 61G and blue 61B color filters which, as the wheel 6 rotates, alternately intersect the beam of polychromatic light, generally of white tint, emitted by the white light source 2. In this case, the beam of light emitted by the light source 2 is, having passed through or been reflected off the wheel 6, depending on whether the color segments are transmissive or reflective, alternately a beam of red light R, a beam of green light G, and a beam of blue light B. With reference to FIGS. 2a and 2b, FIG. 2a describes a color wheel 6 with four segments, three colored segments 61R, 61G, 61B and one segment of white tint 61W, known from the prior art and FIG. 2b shows a color wheel 6 with six colored segments colored RGB also known from the prior art.

FIG. 3a shows a color wheel 6 61R-61Y(RG)-61G-61C(GB)-61B-61M(BR) according to a preferred embodiment of the invention, comprising two coplanar subsets of segments, a subset of three colored segments that are transmissive in the range of wavelengths corresponding to red in the case of the red segment 61R, the range of wavelengths corresponding to green in the case of the green segment 61G, and the range of wavelengths corresponding to blue in the case of the blue segment 61B, and a subset of three colored segments that are transmissive in the range of wavelengths corresponding to the composite colors, particularly yellow and/or red and green in the case of the segment of composite colors 61Y(RG), cyan and/or green and blue in the case of the segment of composite colors 61C(GB), and magenta and/or blue and red in the case of the segment of composite colors 61M(BR). The luminous fluxes for yellow, magenta and cyan which are generally transmitted through the composite color segments 61Y(RG) in the case of yellow, 61C(GB) in the case of cyan, and 61M(BR) in the case of magenta, contribute to enhancing the luminosity on the imager. The composite color segments 61C(GB), 61M(BR) and 61Y(RG) are preferably positioned in such a way that each of said segments is positioned between the two primary-color segments 61R, 61G and 61B, for which it is at least partially transmissive simultaneously in the wavelength ranges.

FIG. 3b shows a color wheel 6 according to a variant of the invention, comprising a subset of primary-color segments 61R, 61G, 61B, a subset of composite-color segments 61Y(RG), 61C(GB), 61M(BR) and a subset of desaturated primary color segments 61R′ in the case of the desaturated red segment, 61G′ in the case of the desaturated green segment and 61B′ in the case of the desaturated blue segment.

FIG. 4 shows a color wheel 6 comprising a subset of primary color segments 61R, 61G, 61B and a second subset of desaturated primary color segments 61R′, 61G′, and 61B′.

FIGS. 5a and 5b show the profile of the emission spectrum S for a light source 12 commonly used in present-day image projection and/or display systems, of the UHP (ultra-high pressure) type, employing mercury for example, with which there are associated, respectively, in the case of FIG. 5a, the profiles of the ranges of wavelengths transmitted by the primary color filters or segments RG and B, and, in the case of FIG. 5b, the profiles of the ranges of the wavelengths transmitted by the composite color filters or segments cyan C, magenta M and yellow Y. By way of example, the ranges of wavelengths for a relative intensity or transmission in excess of 50% for the color filters used are:
in the case of the blue filter B: shorter than 500 nanometers (nm),
in the case of the red filter R: longer than 600 nm,
in the case of the green filter G: between 520 and 564 nm,
in the case of the cyan filter C: shorter than 564 nm,
in the case of the magenta filter M: shorter than 520 and longer than 600 nm,
in the case of the yellow filter Y: between 530 and 684 nm.

It can be seen that the emission spectrum of the source S of the UHP type chosen corresponds in particular to a first emission peak near 440 nanometers that the blue or cyan or magenta colored segments transmit, a second emission peak close to 550 nanometers that the green or cyan or yellow colored segments transmit, and a third emission peak near 580 nanometers that the yellow colored segments transmit. As described earlier, the presence of the composite color segments or filters allows the transmission, in addition to the luminous fluxes corresponding to the primary colors R, G and B, of the luminous fluxes corresponding to cyan, magenta and yellow, which colors are themselves made up, for example, of blue and green in the case of cyan, blue and red in the case of magenta, and red and green in the case of yellow. Thus, a color wheel for example comprising a subset of three primary color segments R, G and B and a subset of three composite color segments C(GB), M(BR) and Y(RG), each of the segments representing one sixth of the disk, namely a segment subtending an angle of 60 degrees at the axis of the disk will be comparable with nine segments also subtending an angle of 60 degrees at the axis, three segments transmitting in the range of wavelengths corresponding to blue B, three segments transmitting in the range of wavelengths corresponding to green G and three segments transmitting in the range of wavelengths corresponding to red R, in addition to the composite color segments which transmit in the ranges of the wavelengths corresponding to cyan C, or magenta M or yellow Y.

FIG. 6 shows the CIE 1931 chromaticity diagram (International Commission on Illumination) for the colors transmitted, on the one hand, through the subset of three primary color segments R, G and B (this is the RGB triangle) and, on the other hand, through the subset of three composite color segments C, M, Y (this is the CMY triangle). Each subset of segments generates a specific white tint. The white tint generated by the subset of composite colors C, M, Y may, because of the tall yellow color peak emitted by the UHP source and transmitted by said subset, be slightly offset toward yellow. However, it is possible to correct the tint of this white in accordance with the specifications of the system using downstream software processing or alternatively by desaturating the yellow color filter 61Y(RG). By way of indication, the white tint W generated by the subset of primary color segments and the subset of composite color segments is visible in the diagram. The organized alternation of primary color segments and composite color segments 61R-61Y(RG)-61G-61C(GB)-61B-61M(BR) on the color wheel 6, according to a preferred embodiment of the invention and shown in FIG. 3, is based on the proximity of the coordinates, on the CIE 1931 chromaticity diagram, of red and magenta, then magenta and blue, then blue and cyan, then cyan and green, then green and yellow, and finally yellow and red. Filing through the colors in this RMBCGY order is less abrupt and therefore reduces the color break-up phenomenon.

FIG. 7 shows the CIE 1931 chromaticity diagram for the colors transmitted, on the one hand, through the subset of the three primary color segments R, G and B (this is the RGB triangle) and, on the other hand, through the subset of three desaturated color segments R′, G′ and B′ (this is the R′G′B′ triangle). In general, it can be seen that the vast majority of the colors in the images which are displayed lie in a relatively narrow range. Given that the colors of the images displayed will not always be saturated, the presence of desaturated segments on the color wheel makes it possible to enhance the luminosity of the image displayed without their quality being adversely affected.

FIG. 8 demonstrates video data management means 11 which receive as input the conventional RGB video signals 9 and convert them into R-M-B-C-G-Y video signals 91, for example according to the preferred embodiment so that synchronization between the color wheel, in this instance the 61R-61Y(RG)-61G-61C(GB)-61B-61M(BR) wheel 6 described in FIG. 3 which allows the imager to be illuminated alternately with light in the following colors: R, Y(RG), G, C(GB), B and M(BR), and the writing of the pixels of the imager is as precise as possible.

FIG. 9 more specifically describes the video data management means 11, particularly the presence of a table 71 of coefficients in memory 7 so as to convert the input signal 9R, 9G and 9B into an RGBCMY output signal 91 for writing to the imager 12.

The preferred embodiment according to the invention consists in the use of a color wheel 6 comprising a subset of three, red, green and blue (RGB) primary color segments and a second subset of three, cyan, magenta and yellow (CMY) composite color segments as described in FIG. 3a, and in which each segment occupies one sixth of the total area of the color wheel. The area of each segment may, however, differ and be tailored in such a way as to obtain a different color balance and/or greater luminosity on the screen. The light source 2, for example of the UHP type, emits a beam of light that the color wheel 6, revolving about its axis, chops sequentially at the color segments 61R, 61Y(RG), 61G, 61C(GB), 61B and 61M(BR) of which it is formed. The beam of colored light resulting from the pass through a segment of the color wheel 6 illuminates an imager 12 comprising pixels. Said pixels of the imager may be aligned or arranged in a staggered or “diamond” configuration, of parallelepipedal or other shape, of the liquid crystal (for example LCOS) type or of the micro-mirrors (for example DMD) type.

The imager 12, illuminated sequentially by a beam of light colored red R, then magenta M, then blue B, then cyan C, then green G and then yellow Y is driven by the video data management means 111 whose task is to write each pixel or group of pixels of the imager 12 in synchronism with the color with which the imager is illuminated. To do that and with reference to FIG. 8, the video data management means 111 which receive video data of the RGB type in the form of three buses 9R, 9G, 9B relating to R, G and B data, process the video signal in order, at output and for the writing to the imager 12, to produce a single bus 91 concerned with R-M-B-C-G-Y output data comprising the video signals SR, SG, SB relating to primary colors R, G and B and video signals SC, SM and SY relating to the composite colors C, M and Y, said signals being synchronized with the color with which the imager 12 is illuminated by virtue, for example, of a measurement device (not depicted) that measures the position of the color wheel 6. The R-M-B-C-G-Y video output data 91 are calculated on the basis of the 9R, 9G, and 9B input data using a set of three multipliers 8, one for each input bus 9, and a summer 13. The SR, SG SB video output signals 91 correspond to the SR SG, SB input signals 9 (KRR=KGG=KBB=1) but the video signals for the composite colors C, M and Y are calculated from the coefficients KRR, KRM, KRB, KRC, KRG, KRY, KGR, KGM, KGB, KGC, KGG, KGY, KBR, KBM, KBB, KBC, KBG, KBY contained in a table 71 contained in memory 7.

For example, the values of SC, SM and SY are calculated from SR, SG and SB as follows:
SC=KGC*SG+KBC*SB+KRC*SR
SM=KGM*SG+KBM*SB+KRM*SR
SY=KGY*SG+KBY*SB+KRY*SR

The values of the coefficients may, for example, be as follows:

| Video output | | | |
|---|---|---|---|
| (91) | Coefficient k_{R} | Coefficient k_{G} | Coefficient k_{B} |
| Red | KRR = 1 | KGR = 0 | KBR = 0 |
| Magenta | KRM = 0.1 to 1 | KGM = 0 | KBM = 0.1 to 1 |
| Blue | KRB = 0 | KGB = 0 | KBB = 1 |
| Cyan | KRC = 0 | KGC = 0.1 to 1 | KBC = 0.1 to 1 |
| Green | KRG = 0 | KGG = 1 | KBG = 0 |
| Yellow | KRY = 0.1 to 1 | KGY = 0.1 to 1 | KBY = 0 |

The table 71 containing the coefficients KRR, KRM, KRB, KRC, KRG, KRY, KGR, KGM, KGB, KGC, KGG, KGY, KBR, KBM, KBB, KBC, KBG, KBY is preferably contained in a memory 7 of the non-volatile EEPROM type for example, and the coefficients are read sequentially in accordance with the position of the color wheel 6.

Another embodiment consists in using a color wheel as shown in FIG. 3b. The wheel 6 comprises three coplanar subsets of color segments 61 and a subset of primary color segments RGB, a subset of composite color segments CMY, and a subset of desaturated primary color segments 61R′ (in the case of the desaturated red segment), 61G′ (in the case of the desaturated green segment), and 61B′ (in the case of the desaturated blue segment). Said desaturated color segments 61R′, 61G′ and 61B′ are preferably organized in such a way that a desaturated primary color segment, 61R′, 61G′ or 61B′ respectively, is adjacent to the non-desaturated primary color segment 61R, 61G or 61B, respectively, of the equivalent tint. This then makes it possible for example to alternate a primary color segment, a desaturated primary color segment and a composite color segment.

Another embodiment shown in FIG. 4 consists in a color wheel comprising two subsets of colored segments: a subset of primary colors R, G, B and a subset of desaturated primary colors R′, G′, B′. In this embodiment, as in the previous embodiments, the levels of saturation and the dimensions of the color segments may be tailored in such a way as to obtain the desired luminosity on the screen. The desaturated color segments are preferably organized in such a way that a desaturated primary color segment is adjacent to the non-desaturated primary color segment of the equivalent tint.

Finally, and whatever the embodiment, the video data management means 111 will contain in memory 7 at least one table 71 of coefficients K′RR, K′RM, K′RB, K′RC, K′RG, K′RY, K′GR, K′GM, K′GB, K′GC, K′GG, K′GY, K′BR, K′BM, K′BB, K′BC, K′BG, K′BY, the values of which coefficients will be tailored in such a way that the output video data 91 for writing to the imager 12 are properly consistent with the color with which the imager 12 is being illuminated.

Of course, the invention is not restricted to the embodiments described above.

In particular, the person skilled in the art will be able to adapt the color wheel to suit and provide other arrangements of color wheel segments, particularly in terms of their order and in terms of their number.

As indicated before, the composite color segments are able to transmit two colors (green-blue; green-red or blue-red). According to a variant of the invention, the green-blue and green-red segments also transmit the colors at intermediate frequencies, cyan and yellow respectively. Thus, the luminosity of the filtered beam is enhanced and the use of a source that emits in the range of wavelengths corresponding to these colored perceptions is optimized.

According to a variant of the invention, the segments of the wheels are purely reflective rather than being used in transmission. Thus, in the projection system illustrated with reference to FIG. 1, the source 2 and the intermediate optical device 3 illuminate a color wheel used in reflection. The axis of the color wheel is preferably inclined with respect to the axis of the imager 12 so that the elements of the illumination system do not impair the propagation of the colored beam obtained by reflection off the color wheel.

According to this variant embodiment of the invention, the color wheel comprises two coplanar subsets of segments:
a subset of three color segments that are reflective in the range of wavelengths corresponding to red in the case of the red segment R, the wavelengths corresponding to green in the case of the green segment G, and the wavelengths corresponding to blue in the case of the blue segment B; and
a subset of three color segments reflective in the range of wavelengths corresponding to the composite colors, particularly red and green and possibly yellow in the case of the composite color segment Y(RG), green and blue and possibly cyan in the case of the composite color segment C(GB), and blue and red and possibly magenta in the case of the composite color segment M(BR), none of said composite colors of the same segment generating a white tint.

The luminous fluxes of yellow, magenta and cyan which are also reflected by the composite color segments Y(RG) in the case of yellow, C(GB) in the case of cyan, and M(BR) in the case of magenta, contribute to enhancing the luminosity on the imager. The composite color segments C(GB), M(BR) and Y(RG) are preferably positioned in such a way that each of the segments is positioned between the two primary color segments R, G and B for which it is at least partially reflective in the wavelength range.

According to one particular embodiment of this variant, the segments of each coplanar subset are positioned in such a way that each composite color segment is positioned between the two primary color segments that this composite color segment reflects. Thus, the color break-up may be significantly lessened.

According to another particular embodiment of this variant, the color wheel comprises at least one coplanar subset of reflective segments of desaturated colors comprising a segment reflecting in the range of wavelengths corresponding to red that is desaturated with respect to the red of the coplanar subset of the primary color segments, a segment reflecting in the range of wavelengths corresponding to green, that is desaturated with respect to the green of the coplanar subset of primary color segments and a segment reflecting in the range of wavelengths corresponding to blue that is desaturated with respect to the blue of the coplanar subset of primary color segments. Thus, the luminosity of the image, averaged over one revolution of the wheel, is improved. In addition, in an embodiment whereby each desaturated color segment is adjacent to the primary color segment of the equivalent tint, in the direction in which the color wheel rotates, the color break-up phenomenon is also reduced.

According to yet another particular embodiment of this variant (color wheel with reflective segment), the color wheel has no black segment. Thus, the luminosity is improved and the color breakup becomes less noticeable.

The color wheel comprising, according to a variant of the invention, segments used in reflection is thus used in a dual manner by comparison with a color wheel comprising transmissive segments according to the embodiments described earlier. The same variants therefore apply to the reflective segments and the advantages are the same. They will therefore not be described further.

In general, the transmissive or reflective segments designed respectively to transmit or to reflect a luminous flux toward an imager may be likened to optical filtering segments designed to propagate a luminous flux toward an imager.

The invention also relates to a front projection or backprojection appliance comprising at least one imager, such a system for the sequential illumination of each imager with transmissive or reflective segments and means for projecting an image created by the imager or imagers, for example an objective lens, one or more reflection mirrors (in the case of a compact or non-compact backprojection appliance) and a screen (in the case of a backprojection appliance).

Thus, the projection appliance comprises, according to the invention, for example, an imager or two imagers (each of the imagers being illuminated by a beam propagated by a color wheel having at least six segments made up of three primary colors and three composite colors; in this case, one and the same color wheel can be used for both imagers (for example in a configuration in which one and the same color wheel is used either in reflection or in transmission for both imagers or alternatively in a configuration in which one and the same color wheel is used in reflection for one imager and in transmission for the other imager) or, by contrast, two separate wheels are used).

1- A system for the sequential illumination of an imager comprising
a source emitting, toward the imager, a beam of polychromatic light in the range of wavelengths containing at least red, green and blue,
optical means for uniformly distributing the light from the source over the working area of the imager,
a color wheel comprising at least two coplanar subsets of transmissive segments, and positioned in such a way that at least one of these segments intersects said beam, mounted on rotation means in such a way as to cause said segments to file in sequence past said beam intersection region, each coplanar subset of segments comprising three coplanar segments of different colors, the tint, saturation, transmissivity and size of which are tailored to make up a reference white when they file in sequence past said intersection region, the color wheel comprising at least one subset of segments of primary colors comprising a segment transmitting in the range of wavelengths corresponding to red, a segment transmitting in the range of wavelengths corresponding to green, and a segment transmitting in the range of wavelengths corresponding to blue, wherein said color wheel comprises at least one subset of coplanar segments of composite colors comprising a yellow segment transmitting at least in part both in the ranges of wavelengths corresponding to red and to green, a cyan segment transmitting at least in part both in the ranges of wavelengths corresponding to green and to blue, and a magenta segment transmitting at least in part both in the ranges of wavelengths corresponding to red and to blue, none of said composite colors of one and the same segment generating a white tint.

2- The system for the sequential illumination of an imager as claimed in claim 1, wherein said range of wavelengths of the beam of polychromatic light emitted by the source also comprises yellow and/or cyan.

3- The system for the sequential illumination of an imager as claimed in claim 2, wherein, in the at least one coplanar subset of segments of composite colors, said segment transmitting at least in part both in the ranges of wavelengths corresponding to red and to green also transmits at least in part in the range of wavelengths equivalent to tones of yellow, and/or said segment transmitting at least in part both in the ranges of wavelengths corresponding to green and to blue also transmits at least in part in the range of wavelengths equivalent to tones of cyan, and/or said segment transmitting at least in part both in the ranges of wavelengths corresponding to red and to blue also transmits at least in part in the ranges of wavelengths equivalent to tones of magenta.

4- The system for the sequential illumination of an imager as claimed in claim 1, wherein the segments of each coplanar subset are positioned in such a way that each segment of composite color is positioned between the two segments of primary color that this composite color segment transmits.

5- The system for the sequential illumination of an imager as claimed in claim 1, wherein said color wheel comprises at least one coplanar subset of segments of desaturated colors comprising a segment transmitted in the range of wavelengths corresponding to red desaturated with respect to the red of the red segment of the coplanar subset of segments of primary colors, a segment transmitting in the range of wavelengths corresponding to green, desaturated with respect to the green of the green segment of the coplanar subset of segments of primary colors, and a segment transmitting in the range of wavelengths corresponding to blue, desaturated with respect to the blue of the blue segment of the coplanar subset of segments of primary colors.

6- The system for the sequential illumination of an imager as claimed in claim 5, wherein the segments of desaturated colors are positioned in such a way that each segment of desaturated color is adjacent to the primary-color segment of equivalent tint.

7- The system for the sequential illumination of an imager as claimed in claim 1, wherein said color wheel comprises no black segment.

8- A system for viewing images comprising:
an imager comprising an array of pixels arranged in rows and columns;
a projection lens designed to project the image of said imager onto a projection screen; and
an illumination system. Illuminating sequentially the imager, the illumination system comprising
a source emitting, toward the imager, a beam of polychromatic light in the range of wavelengths containing at least red, green and blue,
optical means for uniformly distributing the light from the source over the working area of the imager,
a color wheel comprising at least two coplanar subsets of transmissive segments, and positioned in such a way that at least one of these segments intersects said beam, mounted on rotation means in such a way as to cause said segments to file in sequence past said beam intersection region, each coplanar subset of segments comprising three coplanar segments of different colors, the tint, saturation, transmissivity and size of which are tailored to make up a reference white when they file in sequence past said intersection region, the color wheel comprising at least one subset of segments of primary colors comprising a segment transmitting in the range of wavelengths corresponding to red, a segment transmitting in the range of wavelengths corresponding to green, and a segment transmitting in the range of wavelengths corresponding to blue,
said color wheel comprising at least one subset of coplanar segments of composite colors comprising a yellow segment transmitting at least in part both in the ranges of wavelengths corresponding to red and to green, a cyan segment transmitting at least in part both in the ranges of wavelengths corresponding to green and to blue, and a magenta segment transmitting at lest in part both in the ranges of wavelengths corresponding to red and to blue, none of said composite colors of one and the same segment generating a white tint.

9- The system for viewing images as claimed in claim 8, comprising:
video data management means for managing the video data of said images so as to command writing of the pixels of the imager, said video data management means comprising a video input interface for receiving the video input data regarding the primary colors, a video output interface for sending the video output data for writing to the imager, and a memory,
synchronizing means for synchronizing the video output data according to the color of illumination on the imager,
wherein the video data management means comprise, in memory, at least one table of coefficients and/or values for converting the video input data regarding primary colors into video output data (91) regarding primary colors and/or composite colors and/or desaturated colors.

10- A system (1) for the sequential illumination of an imager comprising:
a source emitting, toward the imager, a beam of polychromatic light in the range of wavelengths containing at least red, green and blue,
optical means for uniformly distributing the light from the source over the working area of the imager, and
a color wheel comprising at least two coplanar subsets of reflective segments, and positioned in such a way that at least one of these segments intersects said beam, mounted on rotation means in such a way as to cause said segments to file in sequence past said beam intersection region, each coplanar subset of segments comprising three coplanar segments of different colors, the tint, saturation, reflectivity and size of which are tailored to make up a reference white when they file in sequence past said intersection region, the color wheel comprising at least one subset of segments of primary colors comprising a segment reflecting in the range of wavelengths corresponding to red, a segment reflecting in the range of wavelengths corresponding to green, and a segment reflecting in the range of wavelengths corresponding to blue, wherein said color wheel comprises at least one subset of coplanar segments of composite colors comprising a yellow segment reflecting at least in part both in the ranges of wavelengths corresponding to red and to green, a cyan segment reflecting at least in part both in the ranges of wavelengths corresponding to green and to blue, and a magenta segment reflecting at least in part both in the ranges of wavelengths corresponding to red and to blue, none of said composite colors of one and the same segment generating a white tint.

11- A projection appliance, comprising:
at least one imager;
means for projecting an image created by said imager or imagers; and
a system for the sequential illumination of each of said imagers;
the system for the sequential illumination comprising
a source emitting, toward the imager, a beam of polychromatic light in the range of wavelengths containing at least red, green and blue,
optical means for uniformly distributing the light from the source over the working area of the imager,
a color wheel comprising at least two coplanar subsets of transmissive segments and positioned in such a way that at least one of these segments intersects said beam, mounted on rotation means in such a way as to cause said segments to file in sequence past said beam intersection region, each coplanar subset of segments comprising three coplanar segments of different colors, the tint, saturation, transmissivity and size of which are tailored to make up a reference white when they file in sequence past said intersection region, the color wheel comprising at least one subset of segments of primary colors comprising a segment transmitting in the range of wavelengths corresponding to red, a segment transmitting in the range of wavelengths corresponding to green, and a segment transmitting in the range of wavelengths corresponding to blue,
said color wheel comprising at least one subset of coplanar segments of composite colors comprising a yellow segment transmitting at least in part both in the ranges of wavelengths corresponding to red and to green, a cyan segment transmitting at least in part both in the ranges of wavelengths corresponding to green and to blue, and a magenta segment transmitting at lest in part both in the ranges of wavelengths corresponding to red and to blue, none of said composite colors of one and the same segment generating a white tint.
